(19) United States
(12) Patent Application Publication
(10) Pub. No.: US 2025/0224582 A1
(43) Pub. Date: Jul. 10, 2025

(54) RACK FIBER DISTRIBUTION UNIT AND METHOD FOR HIGH DENSITY CABLE ROUTING

(71) Applicant: AFL Telecommunications LLC, Duncan, SC (US)

(72) Inventors: Asher Leong Raven, Milton Keynes (GB); Keith Sullivan, Kent (GB)

(21) Appl. No.: 19/009,247

(22) Filed: Jan. 3, 2025

Related U.S. Application Data
(60) Provisional application No. 63/617,938, filed on Jan. 5, 2024.

(51) Int. Cl. G02B 6/44

(52) U.S. Cl. CPC G02B 6/4452

(57) ABSTRACT

A fiber distribution unit and system and method for high-density cable routing are provided. The unit, system, and method include positioning a fiber distribution unit alongside a computing equipment at a rack including a plurality of fiber ports. The fiber distribution unit includes a plurality of fiber connection adapters. Positioning the fiber distribution unit includes forming a plurality of sections including fiber connection adapters of the pair of fiber distribution units aligned along a width direction with the fiber ports of the computing equipment. Each section extends along a single rack unit. The system includes a 1:1 ratio of fiber ports to fiber connection adapters at the plurality of sections.

### PRIORITY STATEMENT

The present disclosure claims the benefit of priority to U.S. provisional patent application 63/617,938, filed Jan. 5, 2024, the disclosure of which is incorporated by reference herein in its entirety.

### FIELD

The present disclosure relates generally to structures for telecommunications equipment, and more particularly, to telecommunications racks and systems for cable routing and connection.

### BACKGROUND

Speed of deployment of optical networks is critical for organizations to begin earning revenue from their capital expenditure. As such some methods of deploying optical networks, specifically splicing, requires skilled labor and can be time consuming, approximately 5 minutes per 12 fiber ribbon splice.

Additionally, with the acceleration of artificial intelligence (AI) deployments in datacenters, the connectivity between AI graphical processing unit (GPU) clusters has increased greatly. This may lead to a significant increase in required fiber counts going into server equipment racks and network switch equipment racks. These equipment racks may further require accommodating additional servers or network switches. As a result, space in the rack for traditional fiber optic connectivity becomes limited.

An adverse effect of additional equipment in the racks is significantly greater low fiber count fiber cables entering the equipment rack and therefore occupying valuable volume inside the rack.

Accordingly, improved methods and apparatus that facilitate improved optical network deployment and/or address one or more above identified issues are desired in the art and would be advantageous.

### BRIEF DESCRIPTION

Aspects and advantages of the invention will be set forth in part in the following description, may be apparent from the description, or may be learned through practice of the invention.

An aspect of the present disclosure is directed to a system for telecommunications cable routing. The system includes a rack including a plurality of sidewalls separated from one another along a width direction to form an interior volume therebetween. Computing equipment is positioned at the interior volume of the rack. The computing equipment includes a plurality of fiber ports. A pair of fiber distribution units is positioned alongside respective sidewalls. Each fiber distribution unit includes a plurality of fiber connection adapters. The system includes a plurality of sections including fiber connection adapters of the pair of fiber distribution units aligned along the width direction with the fiber ports of the computing equipment. Each section extends along a single rack unit. The system includes a 1:1 ratio of fiber ports to fiber connection adapters at the plurality of sections.

Another aspect is directed to a method for telecommunications cable routing. The method includes positioning a fiber distribution unit alongside a computing equipment at a rack. The computing equipment includes a plurality of fiber ports. The fiber distribution unit includes a plurality of fiber connection adapters. Positioning the fiber distribution unit includes forming a plurality of sections including fiber connection adapters of the pair of fiber distribution units aligned along a width direction with the fiber ports of the computing equipment. Each section extends along a single rack unit. The system includes a 1:1 ratio of fiber ports to fiber connection adapters at the plurality of sections.

These and other features, aspects and advantages of the present invention will become better understood with reference to the following description and appended claims. The accompanying drawings, which are incorporated in and constitute a part of this specification, illustrate embodiments of the invention and, together with the description, serve to explain the principles of the invention.

### BRIEF DESCRIPTION OF THE DRAWINGS

A full and enabling disclosure of the present invention, including the best mode thereof, directed to one of ordinary skill in the art, is set forth in the specification, which makes reference to the appended figures.

FIG. 1 illustrates an embodiment of a system for cable routing including an embodiment of a rack apparatus and embodiments of a fiber distribution unit in accordance with aspects of the present disclosure;

FIG. 2 illustrates a detailed view of a portion of the rack apparatus in accordance with aspects of the present disclosure;

FIG. 3 illustrates an embodiment of a patch panel of the system in accordance with aspects of the present disclosure;

FIG. 4 illustrates a perspective view of an embodiment of the fiber distribution unit in accordance with aspects of the present disclosure;

FIG. 5 illustrates a perspective view of an embodiment of the fiber distribution unit in accordance with aspects of the present disclosure;

FIG. 6 illustrates a perspective view of an embodiment of the fiber distribution unit in accordance with aspects of the present disclosure;

FIG. 7 illustrates a perspective view of an embodiment of the fiber distribution unit in accordance with aspects of the present disclosure;

FIG. 8 illustrates a perspective view of an embodiment of a fiber distribution unit in accordance with aspects of the present disclosure;

FIG. 9 provides a table outlining configuration of a switch rack in accordance with aspects of the present disclosure;

FIG. 10 provides a table outlining exemplary configurations of the system in accordance with aspects of the present disclosure;

FIG. 11 provides a table outlining a configuration of the system in accordance with aspects of the present disclosure;

FIG. 12 illustrates a schematic embodiment of the system and method for cable routing in accordance with aspects of the present disclosure;

FIG. 13 illustrates a schematic embodiment of the system and method for cable routing in accordance with aspects of the present disclosure;

FIG. 14 illustrates a schematic embodiment of the system and method for cable routing in accordance with aspects of the present disclosure;

FIG. 15 illustrates a schematic embodiment of the system and method for cable routing in accordance with aspects of the present disclosure.

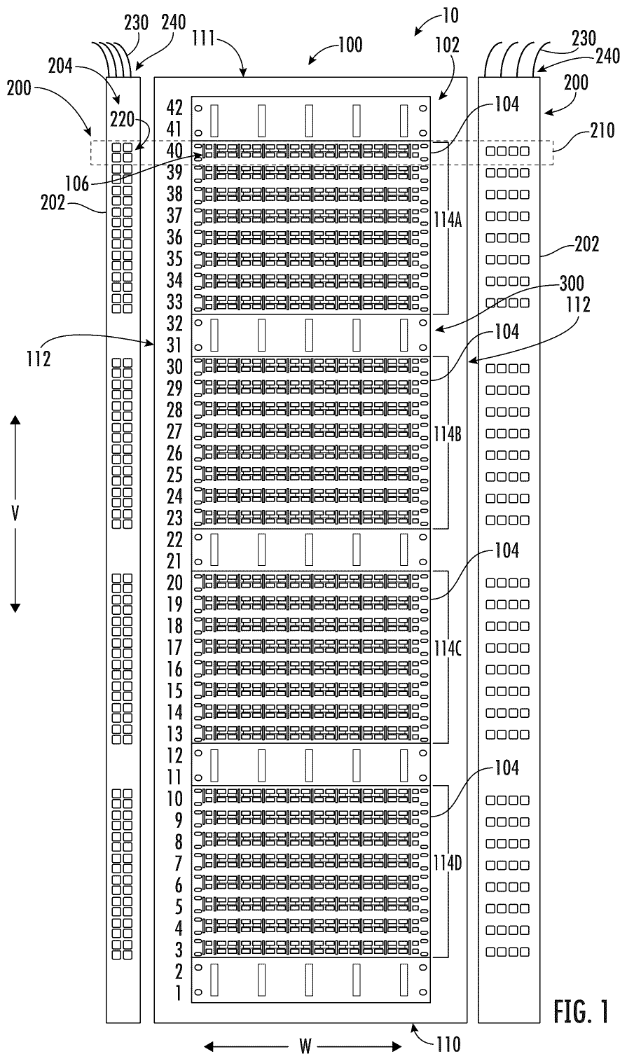

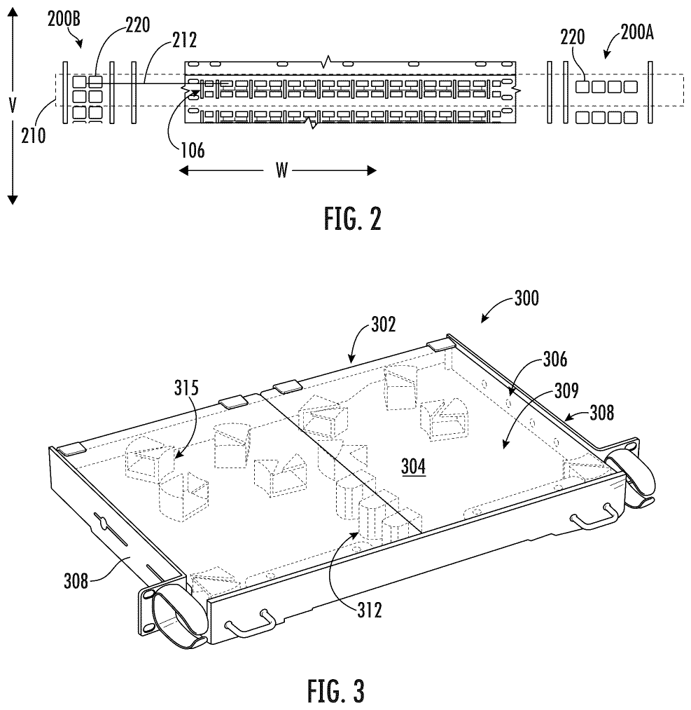

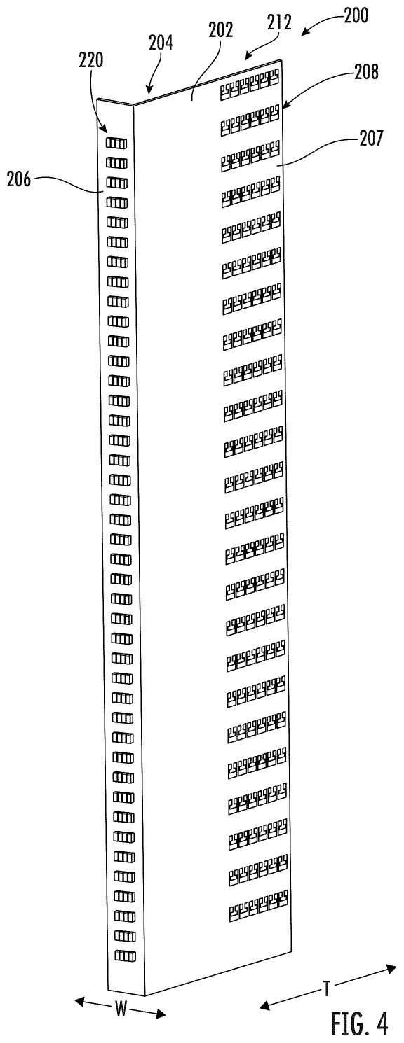

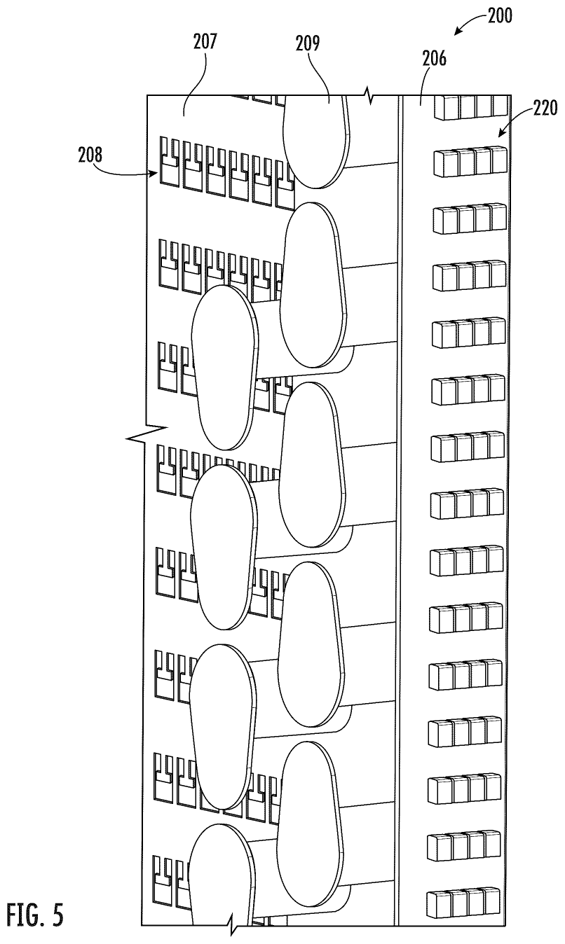

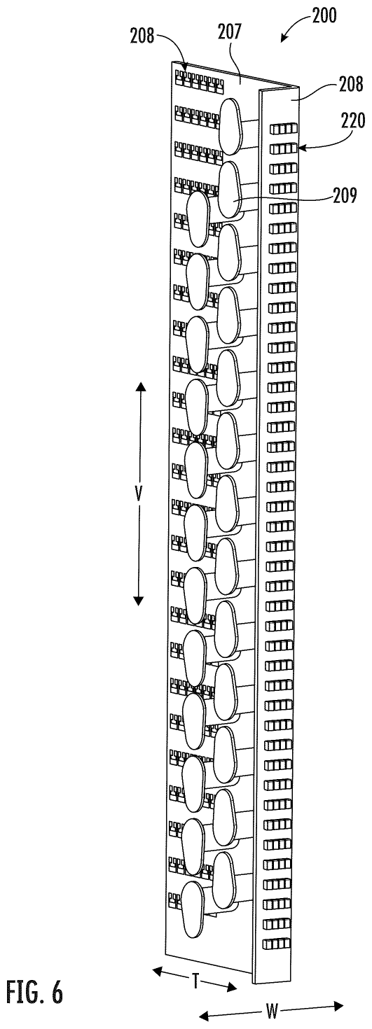

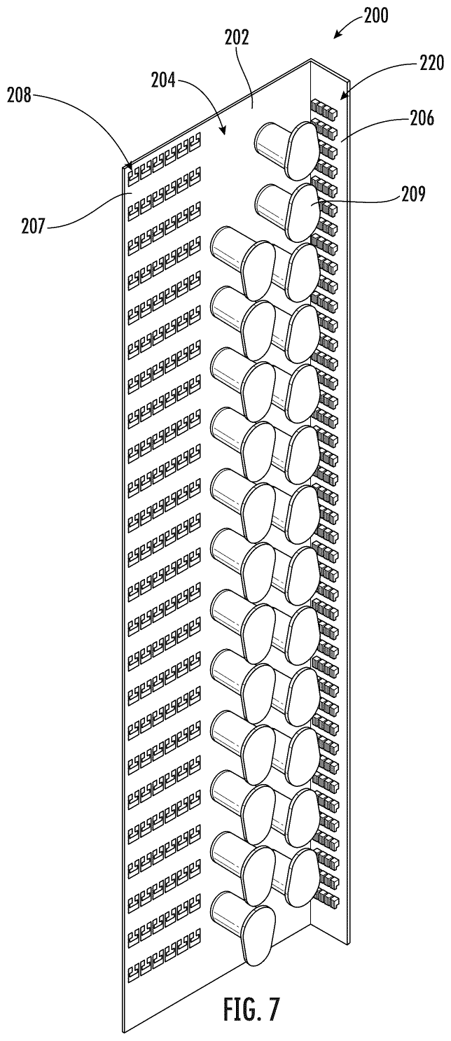

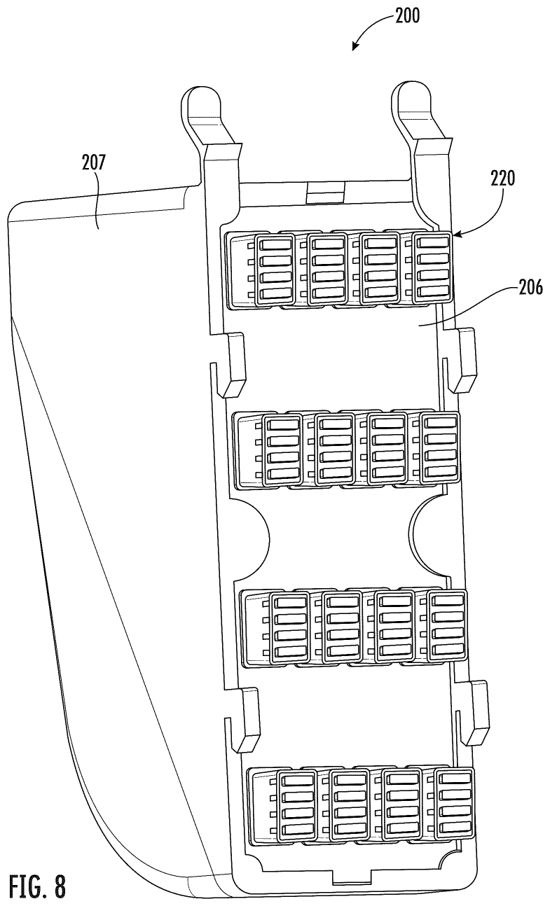

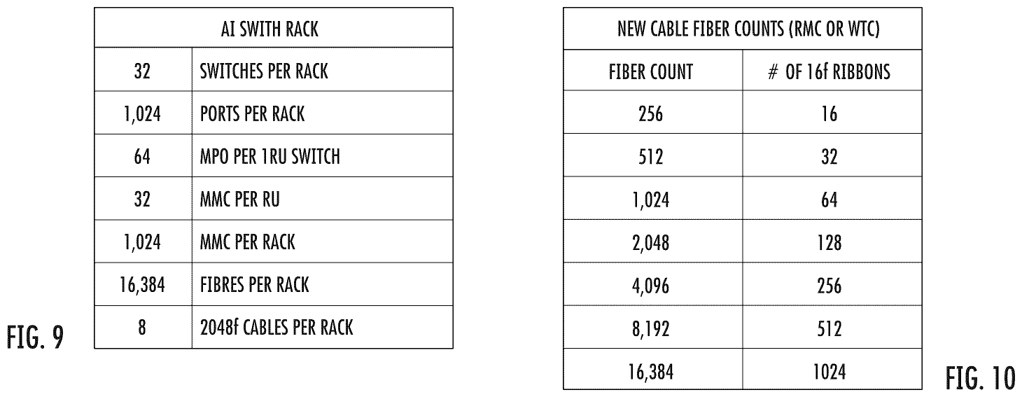

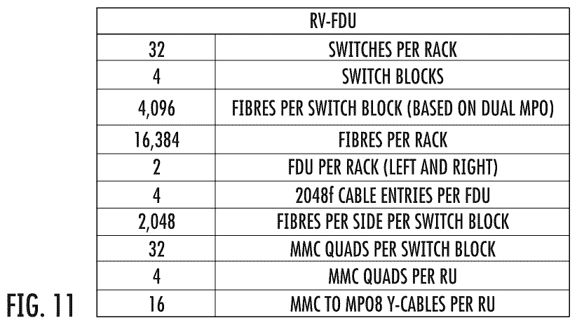

### DETAILED DESCRIPTION

Reference now will be made in detail to embodiments of the invention, one or more examples of which are illustrated in the drawings. Each example is provided by way of explanation of the invention, not limitation of the invention. In fact, it will be apparent to those skilled in the art that various modifications and variations can be made in the present invention without departing from the scope or spirit of the invention. For instance, features illustrated or described as part of one embodiment can be used with another embodiment to yield a still further embodiment. Thus, it is intended that the present invention covers such modifications and variations as come within the scope of the appended claims and their equivalents.

As used herein, the terms “first,” “second,” and “third” may be used interchangeably to distinguish one component from another and are not intended to signify location or importance of the individual components. The terms “includes” and “including” are intended to be inclusive in a manner similar to the term “comprising.” Similarly, the term “or” is generally intended to be inclusive (i.e., “A or B” is intended to mean “A or B or both”). In addition, here and throughout the specification and claims, range limitations may be combined and/or interchanged. Such ranges are identified and include all the sub-ranges contained therein unless context or language indicates otherwise. For example, all ranges disclosed herein are inclusive of the endpoints, and the endpoints are independently combinable with each other. The singular forms “a,” “an,” and “the” include plural references unless the context clearly dictates otherwise.

Approximating language, as used herein throughout the specification and claims, may be applied to modify any quantitative representation that could permissibly vary without resulting in a change in the basic function to which it is related. Accordingly, a value modified by a term or terms, such as “generally,” “about,” “approximately,” and “substantially,” are not to be limited to the precise value specified. In at least some instances, the approximating language may correspond to the precision of an instrument for measuring the value, or the precision of the methods or machines for constructing or manufacturing the components and/or systems. For example, the approximating language may refer to being within a 10 percent margin, i.e., including values within ten percent greater or less than the stated value. In this regard, for example, when used in the context of an angle or direction, such terms include within ten degrees greater or less than the stated angle or direction, e.g., “generally vertical” includes forming an angle of up to ten degrees in any direction, e.g., clockwise or counterclockwise, with the vertical direction V.

The word “exemplary” is used herein to mean “serving as an example, instance, or illustration.” In addition, references to “an embodiment” or “one embodiment” does not necessarily refer to the same embodiment, although it may. Any implementation described herein as “exemplary” or “an embodiment” is not necessarily to be construed as preferred or advantageous over other implementations. Moreover, each example is provided by way of explanation of the invention, not limitation of the invention. In fact, it will be apparent to those skilled in the art that various modifications and variations can be made in the present invention without departing from the scope of the invention. For instance, features illustrated or described as part of one embodiment can be used with another embodiment to yield a still further embodiment. Thus, it is intended that the present invention covers such modifications and variations as come within the scope of the appended claims and their equivalents.

Dimensions provided herein may include approximations of +/−2% of any discrete quantity, or approximations of +2% of a maximum value over a given range or −2% of the maximum value under the given range, unless otherwise provided herein.

As used herein, the term “rack unit” (RU) is understood by those skilled in the art as a unit of measure of approximately 1.75 inches (in) or approximately 44.45 millimeters (mm), or up to 0.03125 in or 0.794 mm less when applied to telecommunications equipment attached to a mount structure.

Embodiments of a system for cable routing 10, rack apparatus 100 (hereinafter, “rack 100”), a rack-vertical fiber distribution unit (FDU) 200 or RV-FDU, and a method for cable routing (hereinafter, “method 1000”) are provided that address one or more of the issues described herein. Embodiments of the method 1000 may provide a method for high density fiber optic cable routing, such as illustrated and described herein.

The rack 100 may generally include a base wall 110 and a top wall 111 separated from one another along a vertical direction V. The rack 100 includes sidewalls 112 extending along the vertical direction V between the base and top walls 110, 111 and separated from one another along a width direction W. An interior volume 102 is formed between the walls 110, 111, 112.

Computing equipment 104, such as patch panels, servers, storage devices (e.g., transitory or non-transitory computer-readable medium or other memory devices), or network switches, is positioned in the interior volume 102. The equipment 104 includes fiber port(s) 106 configured to receive fibers from the FDU 200, such as further described herein. In various embodiments, equipment 104 is positioned on racks, plates, or rails extending along the width direction W in the interior volume 102. The racks or mounting rails may include 19-inch rails, or 23-inch rails, or other sized rails, including other standard rack-size rails as may generally be understood in the art.

In various embodiments, the system 10 includes the FDU 200 positioned outside of the interior volume 102 of the rack 100. In various embodiments, the FDU 200 is mounted to one or more sidewalls 112 outside of the interior volume 102, or attached to a bracket or mount outside of the mounting rail. In still various embodiments, the system 10 positions the FDU 200 onto the rack 100 outside of the interior volume 102, such as to allow for equipment 104 to position in the interior volume 102.

In some embodiments, the system 10 includes the FDU 200 mounted in the rack 100 within a vertically extending volume alongside the interior volume 102. For instance, the volume may include a Vertical Cable Manager volume at the rack 100.

In various embodiments, FDU 200 extends substantially along the vertical direction V, such as alongside an extension of the sidewall 112 along the vertical direction V. In some embodiments, the FDU 200 forms a slimline long rectangular section. For instance, the FDU 200 may include walls 202 forming a plurality of sides (e.g., two walls, or three walls, etc.) forming a channel 204 therebetween. In various embodiments, the FDU 200 extends for a full distance along the vertical direction V corresponding substantially to the sidewall 112. In still various embodiments, the FDU 200 extends for a partial distance along the vertical direction V. In some embodiments, the walls 202 extend between approximately 0.5 meters and approximately 2.5 meters along the vertical direction V (e.g., when mounted to the rack 100). A rear side of the FDU 200 may include a cover that may at least partially obscure the channel 204 from an exterior.

Embodiments of the system 10 and method 1000 may generally remove a bulk of low fiber-count cables in a vertical cable manager volume at the rack 100 with an Ultra High Fiber Count distribution system and method for distribution. Embodiments of the system 10, rack 100, FDU 200, and method 1000 may generally include positioning or arranging equipment 104 to the interior volume 102 at the rack 100 substantially orthogonal to the FDU 200. In some embodiments, the equipment 104 is positioned at the rack 100 such that fiber ports 106 are positioned substantially orthogonal to fiber connection ports or adapter 220 at the FDU 200. The FDU 200 is mounted to the rack 100 in substantially vertical arrangement, such as alongside the sidewalls 112, to position fiber connection ports or adapters 220 at the FDU 200 in alignment along the vertical direction V with fiber ports 106 at the equipment 104. The system 10 and method 1000 may form a plurality of sections or matrices 210 having adapters 220 at the FDU 200 grouped to align with ports 106 at the equipment 104. Fiber optic jumpers or multi-fiber cables, such as depicted schematically at 212, are allowed to connect from the FDU 200 to the equipment 104 orthogonally to the FDU 200. For instance, jumpers or cables 212 extend substantially along a horizontal direction, such as along width direction W, between the FDU 200 and equipment 104, or between respective adapters 220 and ports 106.

In various embodiments, at least one of the walls 202 includes a face 206 at which arrays of adapters 220 are positioned. The face 206 may extend substantially along the width direction W, such as substantially co-directional to a direction of extension of the jumpers or cables 212 extending between the adapters 220 and ports 106.

In some embodiments, at least one of the walls 202 includes an opening 208 through which fibers are allowed to extend from an exterior and into channel 204 to operably couple to the adapters 206. For instance, at least one of the walls 202 includes a second face 207 at which one or more openings 208 is positioned. Face 207 may extend substantially orthogonal to face 206, such as extending along a transverse direction T orthogonal to the width direction W and vertical direction V.

In still some embodiments, one or more organizer members 209 extends from the face 207 into channel 204, such as to provide for mounting and organization of fibers, cables, ribbons, etc. at the channel 204.

In some embodiments, the FDU 200 is configured to include an egress opening 240 configured to ingress or egress cables 230 from the channel 204 and the adapters 220. For instance, method 1000 may include routing cables 230 from adapter 220 along the vertical direction V through opening 240.

In various exemplary embodiments of the system 10 and method 1000, the FDU 200 receives a plurality of Ultra High Fiber Count (UHFC) cables. The method 1000 includes operably coupling the cables to adapters 220. For instance, cables may extend through opening(s) 208 into channel 204 to operably couple to adapters 220. In various embodiments, the UHFC cable is at least 288 fibers. In some embodiments, the UHFC cable is at least 432 fibers. Method 1000 may include receiving the cables as including ribbon fibers. For instance, method 1000 may include routing, to the FDU, ribbonized fibers. In various embodiments, the ribbonized fibers may be bare ribbon, such as allowing for substantially greater quantities of fibers over single-fiber jumper cables. In an exemplary embodiments, the ribbonized fiber may include a 3,456-fiber cable having a diameter of approximately 26-30 millimeters (mm), or between approximately 27-28 mm. In such an exemplary embodiment, the bare ribbonized fibers may remove or obviate 1,000 single-fiber jumper cables, such as to promote the UHFC arrangement.

In various embodiments, method 1000 includes pre-terminating the cables that route to the FDU with multi-fiber connectors. For instance, the pre-terminated cables may include MPO, MMC, SN-MT, or other multi-fiber connector. Method 1000 includes operably coupling to the adapters 220 by plugging the cables to the arrays of adapters 220. Sections or matrices of arrays of adapters 220 align with equipment 104 at the interior volume 102, such as to allow for operably coupling the adapters 220 to the ports 106 at the equipment by extending a jumper or other cable horizontally between the adapters 220 and the ports 106.

In an exemplary embodiment of the system 10 and method 1000, the rack 100 includes four (4) switch blocks 114A, 114B, 114C, 114D. Each switch block 114 may include thirty-two (32) switches or fiber ports 106. Each matrix or section 210 may include a distribution of ports 106 (e.g., along the width direction W) of eight (8) ports 106. In an exemplary embodiment, each switch block 114A, 114B, 114C, 114D includes 4,096 fibers. For instance, each switch block 114 may include dual MPO or other multi-fiber connectors. In another instance, each switch may include up to 128 fibers. In such embodiments, the rack 100 may include 16,384 fibers per rack. In still various embodiments, the system 10 and method 1000 includes two (2) FDUs 200 per rack 100 (e.g., positioned along sidewalls 112 or at brackets, rails, plates, etc. at the rack 100). Each FDU 200 may be configured for 2,048 fibers per corresponding switch block 114 at the rack 100.

In an embodiment, each FDU 200 may be configured to include 256 fibers per matrix or section 210. In some embodiments, the 256 fibers are arranged across four (4) adapters 220 at the FDU 200. Each switch block 114 and FDU 200 may include eight (8) corresponding sections 210.

In another embodiment, each FDU 200 may be configured to include 512 fibers per matrix or section 210. In some embodiments, the 512 fibers are arranged across eight (8) adapters 220 at the FDU 200.

In a still exemplary embodiment, the jumpers or cables 212 may include MMC to MP08 configured extending between the FDU 200 and equipment 104. The system 10 may include sixteen (16) jumper or cables 212 per FDU 200 per rack unit or section 210. Each section 210 may include four (4) MMC arrays per rack unit. The system 10 may include thirty-two (32) MMC arrays per switch block 114.

For instance, in some embodiments, FDU 200 may include four (4) MMC quad arrays in an inline configuration, such as depicted at adapters 220 at FDU 200A. In another instance, in some embodiments, FDU 200 may include four (4) MMC quad arrays in a stacked configuration, such as depicted at adapters 220 at FDU 200B.

Various embodiments of the system 10 and method 1000 include an approximately 1:1 ratio of ports 106 at the equipment 104 to adapters 220 at the pair of FDUs 200. In some embodiments, the FDU 200 includes a 1:1 ratio of ports 106 to adapters 220 per rack unit, such as depicted at section 210. For instance, each rack unit may include a 1:1 ratio of ports 106 at the equipment to adapters 220 at the FDU 200.

In still various embodiments, the FDU 200 includes a fiber density of at least 8 ports. The FDU 200 includes a fiber density including at least 256 fibers and up to 4,096 fibers. In an embodiment, the FDU 200 includes a fiber density of 1,024 fibers or less across eight (8) ports per section 210.

TABLE 1
RV-FDU

| | |
|---|---|
| 32 | Switches per rack |
| 4 | Switch blocks |
| 4,096 | Fibers per switch block |
| | (e.g., based on Dual MPO) |
| 16,384 | Fibers per rack |
| 2 | FDU per rack (left and right) |
| 4 | 2048f Cable entries per FDU |
| 2,048 | Fibers per side per switch block |
| 32 | MMC Quads per switch block |
| 4 | MMC Quads per RU |
| 16 | MMC to MPO8 Y-Cables per RU |

Various embodiments of the system 10 and method 1000 depicted and described herein may facilitate quantities of fiber counts and ribbonized fibers, such as provided in the following table:

TABLE 2
Cable Fiber Counts (RMC or WTC)

| Fiber Count | Quantity of 16f Ribbons |
|---|---|
| 256 | 16 |
| 512 | 32 |
| 1,024 | 64 |
| 2,048 | 128 |
| 4,096 | 256 |
| 8,192 | 512 |
| 16,384 | 1024 |

In an exemplary embodiment, the rack 100 may include equipment 104 configured as a switch rack. The switch rack 100 may be configured for a high fiber application, such as for artificial intelligence (AI) deployments. AI deployments generally require increasingly larger quantities of fibers. Increasing equipment at existing racks may result in equipment being placed above the rack (e.g., above the top wall 111), which may generally require use of a hoist, ladder, cherry picker, lift, or other device configured to raise a person along the vertical direction. Use of such equipment can be exceedingly cumbersome, such as to introduce higher costs, longer times for connection, patching, or other servicing, or increase the time required to set up and maintain the system and connections.

An exemplary embodiment of the rack 100 may include switches, connectors, ports, fibers, and corresponding ratios per rack unit or section 210 such as provided in the following table:

TABLE 3
AI Switch Rack

| | |
|---|---|
| 32 | Switches per rack |
| 1,024 | Ports per rack |
| 64 | MPO per 1RU Swich |
| 32 | MMC per RU |
| 1,024 | MMC per rack |
| 16,384 | Fibers per rack |
| 8 | 2048f Cables per rack |

Embodiments of the system 10 and method 1000 may include embodiments of the rack 100 including equipment 104 and/or panels 300 such as provided in Table 3 may include switches, ports, fibers, and corresponding counts in multiples of 32 corresponding to embodiments of the FDU 200 including quantities of fibers, such as ribbonized fibers, in multiples of 16, such as provided in Table 2.

In some embodiments, the rack 100 may include a patch panel 300 including switches per rack, switch blocks, fibers per switch block, and fibers per rack, such as provided in the following table:

TABLE 4
2RU Sliding Panel

| | |
|---|---|
| 32 | Switches per rack |
| 4 | Switch blocks |
| 4,096 | Fibers per swich block (based on Dual MPO) |
| 16,384 | Fibers per rack |
| 4 | 2RU Sliding panels per rack |
| 4,096 | Fibers per 2RU panel |
| 2 | 2,048f Cable entries per 2RU FDU |
| 64 | MMC Quads per switch block |

In some embodiments, the patch panel 300 extends for one or more rack units, such as two (2) rack units. For instance, the patch panel 300 may include a body 302 corresponding to the rack units such as described. The body 302 forms an interior 304. A removable cover 206 may be positioned at the body 302 over the interior 304. For instance, the patch tray 200 may include one or more, or two, etc. portions of covers 306 disposable over the interior 304. The body 302 includes a plurality of sidewalls 308 extending from a base wall 309. The sidewalls 308 and base wall 309 form the interior 304 at which an adapter bank 312 is positioned. The adapter bank 312 includes a plurality of adapters at which the cables are operably couplable. Embodiments of the patch panel 300 may include an internal wall 315 positioned at the interior 304 and forming one or more pathways for routing cables or fibers at the interior 304.

Some embodiments of the system 10 and method 1000 may include directly terminating the cable (e.g., cable 230) to the FDU 200. Method 1000 may include connecting adapters to the cable 230 and connecting the cable 230 to the FDU 200 at the adapter 220. The FDU 200 may be mounted to a plate, a mount, a rail, etc. at the rack 100.

In still some embodiments, the FDU 200 is mounted vertically in the rack 100, mounted to a top horizontal structural element and a bottom horizontal structural element of the rack 100 (separated along vertical direction V). The FDU 200 may be approximately the same height along vertical direction V as the mounting rails at the rack 100.

Some embodiments of the rack 100 or FDU 200 may include a heat shield, an air deflector, or other thermal management or airflow management elements to desirably direct heat, thermal energy, or fluid flow across the FDU 200, the patch panel 300, the equipment 104, or other operable elements of the system 10.

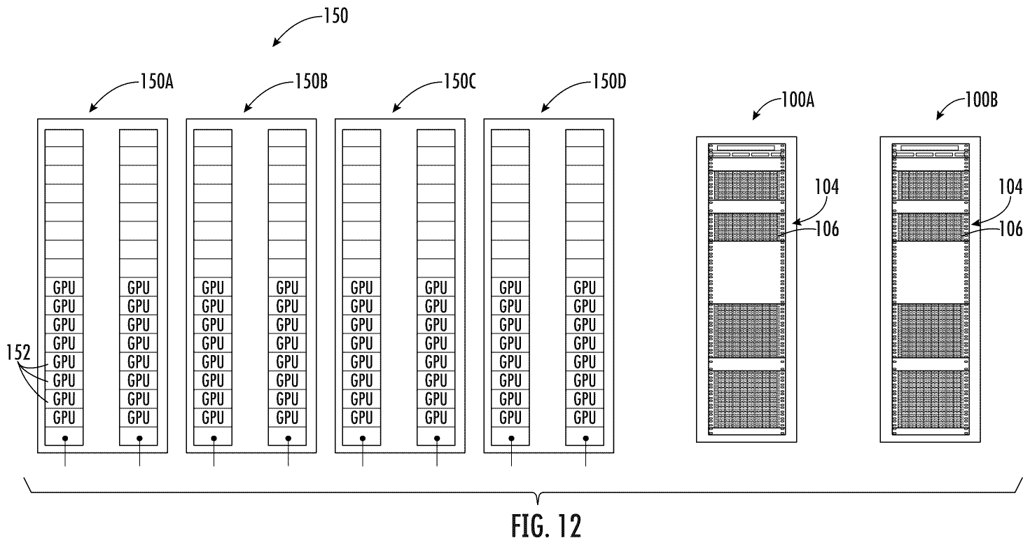

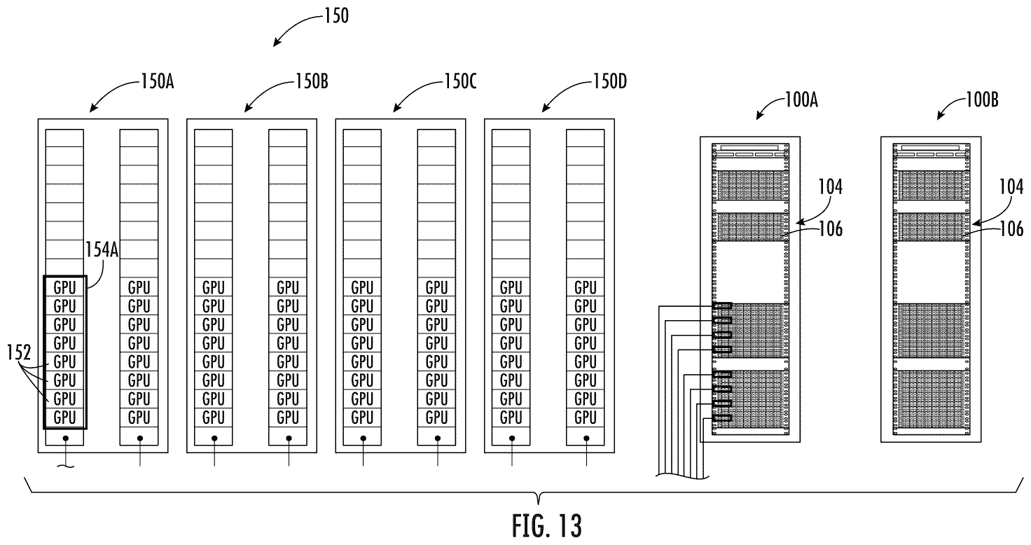

Referring now to FIGS. 12-15, an illustration of an exemplary embodiment of a method for high density cable routing is provided. FIGS. 12-15 depict a pair of switch racks 100A, 100B and a plurality of computing server arrays 150, such as provided as computing server arrays 150A, 150B, 150C, 150D, each including a plurality of servers 152. The computing servers 150 may be configured as GPU clusters, such as for AI applications. In an exemplary embodiment, the method includes operably coupling respective ports 106 at the computer equipment 104 to respective servers 152 at the computing server array 150. A plurality of servers 152 at a respective server array 150 may form a server block 154.

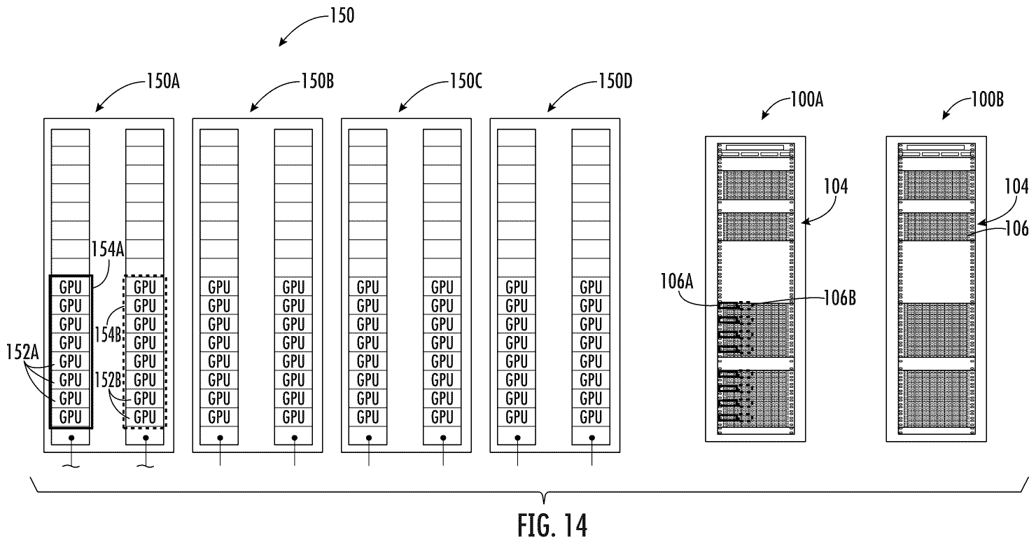

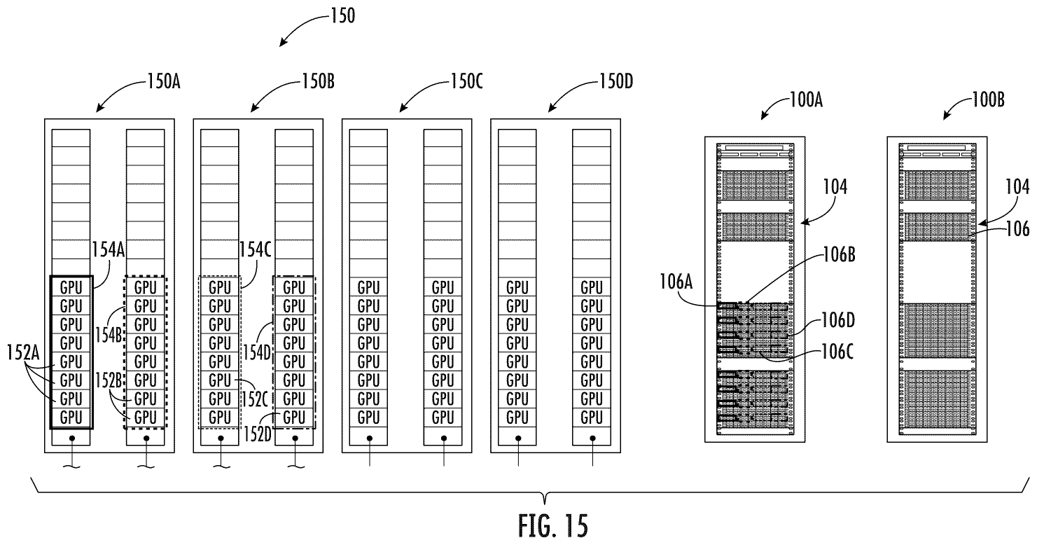

In an embodiment, ports 106, such as provided at ports 106A, are operably coupled to servers 152A at block 154A at computing server array 150A, such as depicted in FIG. 13. FIG. 14 further illustrates operably coupling ports 106B to servers 152B at block 154B at server array 150A. FIG. 15 further illustrates operably coupling ports 106C to servers 152C at block 154C at server array 150B, and operably coupling ports 106D to servers 152D at block 154D at server array 150B.

Various embodiments of the method may include operably coupling ports 106 at switch rack 100 to a respective computing server array 150, such as to form a single-point to a multi-point dense mesh architecture. For instance, first switch rack 100A may include a single 3,456-fiber cable and a single vertical FDU (e.g., FDU 200) at the first switch rack 100A. A 864-fiber cable can span and drop into each of server blocks 154A, 154B, 154C, 154D. Accordingly, a single FDU (e.g., FDU 200) can break-out into four (4) FDUs feeding respective rows of server blocks 154.

Further aspects of the subject matter are provided in the following clauses:
1. A system for telecommunications cable routing, including a rack including a plurality of sidewalls separated from one another along a width direction to form an interior volume therebetween; computing equipment positioned at the interior volume of the rack, wherein the computing equipment includes a plurality of fiber ports; a pair of fiber distribution units positioned alongside respective sidewalls, wherein each fiber distribution unit includes a plurality of fiber connection adapters, wherein the system includes a plurality of sections including fiber connection adapters of the pair of fiber distribution units aligned along the width direction with the fiber ports of the computing equipment, wherein each section extends along a single rack unit, and wherein the system includes a 1:1 ratio of fiber ports to fiber connection adapters at the plurality of sections.
2. The system of any one or more clauses herein, wherein the pair of fiber distribution units includes a fiber density of at least 8 ports including up to 256 fibers.
3. The system of any one or more clauses herein, wherein the rack includes the computing equipment forming a switch block, wherein each switch block includes thirty-two fiber ports, and wherein each section includes at least eight fiber ports.
4. The system of any one or more clauses herein, wherein each fiber port includes up to 128 fibers.
5. The system of any one or more clauses herein, wherein each fiber distribution unit includes up to 4,096 fibers per switch block.
6. The system of any one or more clauses herein, wherein each fiber distribution unit includes up to 256 fibers per section.
7. The system of any one or more clauses herein, wherein each switch block and fiber distribution unit includes eight corresponding sections.
8. The system of any one or more clauses herein, including a jumper cable extending between the fiber connection adapter and the fiber port, wherein the system includes sixteen jumper cables per fiber distribution unit per section.
9. The system of any one or more clauses herein, wherein the system includes at least one fiber connection adapter per fiber distribution unit per section.
10. The system of any one or more clauses herein, wherein the pair of fiber distribution units is positioned outside of the interior volume alongside respective sidewalls.
11. The system of any one or more clauses herein, including a plurality of patch panels each forming a two-rack unit section at the rack, wherein the plurality of patch panels includes thirty-two switches per rack and 16,384 fibers per rack.
12. A method for telecommunications cable routing, the method including positioning a fiber distribution unit alongside a computing equipment at a rack, the computing equipment including a plurality of fiber ports, the fiber distribution unit including a plurality of fiber connection adapters, wherein positioning the fiber distribution unit includes forming a plurality of sections including fiber connection adapters of the pair of fiber distribution units aligned along a width direction with the fiber ports of the computing equipment, wherein each section extends along a single rack unit, and wherein the system includes a 1:1 ratio of fiber ports to fiber connection adapters at the plurality of sections.
13. The method of any one or more clauses herein, the method including routing a cable to the fiber distribution unit and operably coupling the cable to the fiber connection adapter at the fiber distribution unit; and operably coupling a jumper cable to the fiber connection adapter and the fiber ports at the computing equipment.
14. The method of any one or more clauses herein, wherein operably coupling the jumper cable includes sixteen jumper cables per fiber distribution unit per section.
15. The method of any one or more clauses herein, wherein operably coupling the jumper cable includes at least one fiber connection adapter per fiber distribution unit per section.
16. The method of any one or more clauses herein, wherein operably coupling the jumper cable includes operably coupling sixteen jumper cables per fiber distribution unit per section.
17. The method of any one or more clauses herein, wherein the fiber distribution unit includes a fiber density of at least 8 ports including up to 256 fibers.
18. The method of any one or more clauses herein, wherein operably coupling the jumper cable includes the computing equipment forming a switch block, wherein each switch block includes thirty-two fiber ports, and wherein each section includes eight fiber ports.
19. The method of any one or more clauses herein, wherein positioning the fiber distribution unit includes each fiber port including up to 128 fibers, wherein each fiber distribution unit includes up to 2,048 fibers per switch block, and wherein each fiber distribution unit includes up to 256 fibers per section.
20. The method of any one or more clauses herein, including positioning a plurality of patch panels each forming a two-rack unit section at the rack, wherein the plurality of patch panels includes thirty-two switches per rack and 16,384 fibers per rack.
21. The system of any one or more clauses herein, configured to execute steps of the method of any one or more clauses herein.
22. A method for high-density fiber optic cable routing, the method including the steps of the method of any one or more clauses herein.
23. A fiber distribution unit in accordance with any one or more clauses herein.
24. A telecommunications rack including the fiber distribution unit in accordance with any one or more clauses herein.
25. A method for fiber optic connectivity in accordance with any one or more clauses herein.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they include structural elements that do not differ from the literal language of the claims, or if they include equivalent structural elements with insubstantial differences from the literal languages of the claims.

What is claimed is:

1. A system for telecommunications cable routing, comprising:
a rack including a plurality of sidewalls separated from one another along a width direction to form an interior volume therebetween;
computing equipment positioned at the interior volume of the rack, wherein the computing equipment comprises a plurality of fiber ports;
a pair of fiber distribution units positioned alongside respective sidewalls, wherein each fiber distribution unit comprises a plurality of fiber connection adapters, wherein the system comprises a plurality of sections comprising fiber connection adapters of the pair of fiber distribution units aligned along the width direction with the fiber ports of the computing equipment, wherein each section extends along a single rack unit, and wherein the system comprises a 1:1 ratio of fiber ports to fiber connection adapters at the plurality of sections.

2. The system of claim 1, wherein the pair of fiber distribution units comprises a fiber density of at least 8 ports comprising up to 256 fibers.

3. The system of claim 1, wherein the rack comprises the computing equipment forming a switch block, wherein each switch block comprises thirty-two fiber ports, and wherein each section comprises at least eight fiber ports.

4. The system of claim 3, wherein each fiber port comprises up to 128 fibers.

5. The system of claim 3, wherein each fiber distribution unit comprises up to 4,096 fibers per switch block.

6. The system of claim 3, wherein each fiber distribution unit comprises up to 256 fibers per section.

7. The system of claim 3, wherein each switch block and fiber distribution unit comprises eight corresponding sections.

8. The system of claim 1, comprising a jumper cable extending between the fiber connection adapter and the fiber port, wherein the system comprises sixteen jumper cables per fiber distribution unit per section.

9. The system of claim 1, wherein the system comprises at least one fiber connection adapter per fiber distribution unit per section.

10. The system of claim 1, wherein the pair of fiber distribution units is positioned outside of the interior volume alongside respective sidewalls.

11. The system of claim 1, comprising:
a plurality of patch panels each forming a two-rack unit section at the rack, wherein the plurality of patch panels comprises thirty-two switches per rack and 16,384 fibers per rack.

12. A method for telecommunications cable routing, the method comprising:
positioning a fiber distribution unit alongside a computing equipment at a rack, the computing equipment comprising a plurality of fiber ports, the fiber distribution unit comprising a plurality of fiber connection adapters, wherein positioning the fiber distribution unit comprises forming a plurality of sections comprising fiber connection adapters of the pair of fiber distribution units aligned along a width direction with the fiber ports of the computing equipment, wherein each section extends along a single rack unit, and wherein the system comprises a 1:1 ratio of fiber ports to fiber connection adapters at the plurality of sections.

13. The method of claim 12, the method comprising:
routing a cable to the fiber distribution unit and operably coupling the cable to the fiber connection adapter at the fiber distribution unit; and
operably coupling a jumper cable to the fiber connection adapter and the fiber ports at the computing equipment.

14. The method of claim 13, wherein operably coupling the jumper cable comprises sixteen jumper cables per fiber distribution unit per section.

15. The method of claim 13, wherein operably coupling the jumper cable comprises at least one fiber connection adapter per fiber distribution unit per section.

16. The method of claim 13, wherein operably coupling the jumper cable comprises operably coupling sixteen jumper cables per fiber distribution unit per section.

17. The method of claim 12, wherein the fiber distribution unit comprises a fiber density of at least 8 ports comprising up to 256 fibers.

18. The method of claim 13, wherein operably coupling the jumper cable comprises the computing equipment forming a switch block, wherein each switch block comprises thirty-two fiber ports, and wherein each section comprises eight fiber ports.

19. The method of claim 12, wherein positioning the fiber distribution unit comprises each fiber port comprising up to 128 fibers, wherein each fiber distribution unit comprises up to 2,048 fibers per switch block, and wherein each fiber distribution unit comprises up to 256 fibers per section.

20. The method of claim 12, comprising:
positioning a plurality of patch panels each forming a two-rack unit section at the rack, wherein the plurality of patch panels comprises thirty-two switches per rack and 16,384 fibers per rack.
